(19) United States
(12) Patent Application Publication
(10) Pub. No.: US 2012/0124195 A1
(43) Pub. Date: May 17, 2012

(54) Reducing Redundant Error Messages In A Computing System

(75) Inventor: John J. Bird, Rochester, MN (US)

(73) Assignee: INTERNATIONAL BUSINESS MACHINES CORPORATION, Armonk, NY (US)

(21) Appl. No.: 12/946,881

(22) Filed: Nov. 16, 2010

(51) Int. Cl. G06F 15/173

(52) U.S. Cl. 709/224

(57) ABSTRACT

Reducing redundant error messages in a computing system, including: determining whether an endpoint in the computing system is being monitored by two or more management systems; selecting, from among the two or more management systems, a primary management system that is responsible for monitoring the endpoint; and assigning the primary management system to monitor the endpoint.

### BACKGROUND OF THE INVENTION

1. Field of the Invention

The field of the invention is data processing, or, more specifically, methods, apparatus, and products for reducing redundant error messages in a computing system.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Modern computing systems, including the software and hardware components that are part of such computing systems, are frequently monitored by multiple management systems. Multiple management systems often monitor the same computing resource, such that redundant error messages, performance reports, and the like are reported to a reporting repository, causing the reporting repository to become inundated with more information than is necessary to adequately monitor the computing system.

### SUMMARY OF THE INVENTION

Methods, apparatus, and products for reducing redundant error messages in a computing system, including: determining whether an endpoint in the computing system is being monitored by two or more management systems; selecting in dependence upon a negotiation algorithm, from among the two or more management systems, a primary management system that is responsible for monitoring the endpoint; and assigning the primary management system to monitor the endpoint.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1A sets forth a block diagram of apparatus for reducing redundant error messages in a computing system according to embodiments of the present invention.

FIG. 1B sets forth a block diagram of apparatus for reducing redundant error messages in a computing system according to embodiments of the present invention.

FIG. 2 sets forth a block diagram of automated computing machinery comprising an exemplary management system useful in reducing redundant error messages in a computing system according to embodiments of the present invention.

FIG. 3 sets forth a flow chart illustrating an example method for reducing redundant error messages in a computing system according to embodiments of the present invention.

FIG. 4 sets forth a flow chart illustrating an example method for reducing redundant error messages in a computing system according to embodiments of the present invention.

### DETAILED DESCRIPTION OF EXEMPLARY EMBODIMENTS

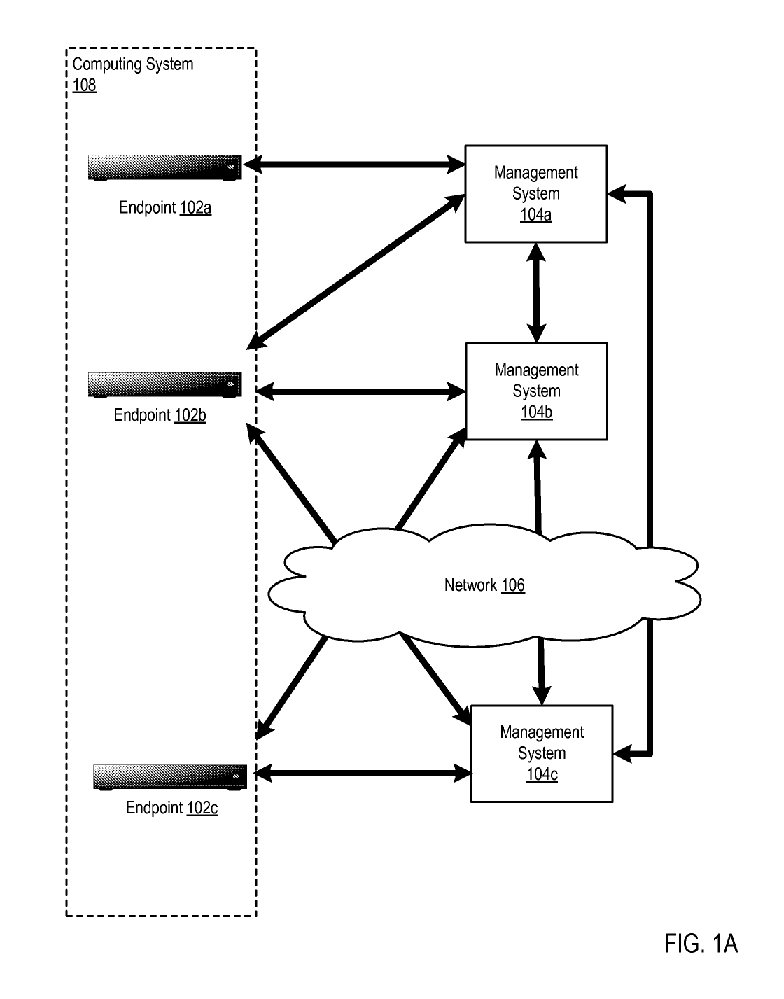

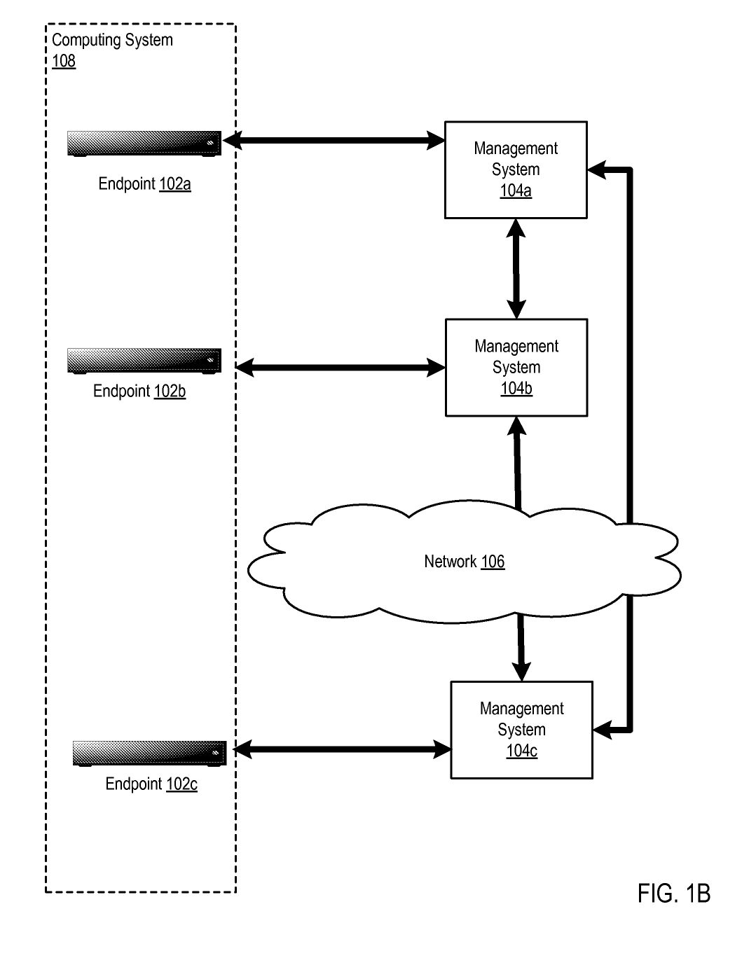

Exemplary methods, apparatus, and products for reducing redundant error messages in a computing system in accordance with the present invention are described with reference to the accompanying drawings, beginning with FIG. 1A. FIG. 1A sets forth a block diagram of apparatus for reducing redundant error messages in a computing system (108) according to embodiments of the present invention. FIG. 1A includes a computing system (108) that includes three endpoints (102a, 102b, 102c). An endpoint is any component of a computing system (108) that may be monitored. Although depicted as a computer, endpoints may be embodied as, for example, a software application, a particular hardware component within a computer such as a processor, memory module, power supply, and so on.

FIG. 1A also includes three management systems (104a, 104b, 104c). A management system (104a, 104b, 104c) is a module of automated computing machinery capable of monitoring the performance of hardware components and software components in a computing system (108). Management systems (104a, 104b, 104c) may monitor hardware components and software components in a computing system (108), for example, by determining that a particular error condition has occurred, by determining that the monitored endpoint (102a, 102b, 102c) has malfunctioned, by measuring or receiving performance criteria related to the operation of the endpoint (102a, 102b, 102c), and so on. Management systems (104a, 104b, 104c) may monitor the general health of the endpoints (102a, 102b, 102c), for example, by pinging the endpoints (102a, 102b, 102c) to verify that an endpoint (102a, 102b, 102c) is operational, by verifying that operating parameters such as power consumption are within acceptable ranges, by verifying that response times of the endpoints (102a, 102b, 102c) are within acceptable ranges, by verifying that resource utilization levels are within acceptable ranges, and so on.

In the example of FIG. 1A, more than one management system (104a, 104b, 104c) is monitoring each endpoint (102a, 102b, 102c). For example, management system (104a) is monitoring endpoint (102a) and endpoint (102b). Similarly, management system (104b) is monitoring endpoint (102b) and endpoint (102c) and management system (104c) is monitoring endpoint (102b) and endpoint (102). Management systems (104a, 104b, 104c) may be physically proximate to the endpoints (102a, 102b, 102c) that they monitor or, alternatively, management systems (104a, 104b, 104c) may be remotely located relative to the endpoints (102a, 102b, 102c) that they monitor. In the example of FIG. 1A, management system (104b) is remotely located relative to endpoint (102c) such that the management system (104b) and the endpoint (102c) must communicate via a data communications network (106). In the example of FIG. 1A, management system (104c) is remotely located relative to endpoint (102b) such that the management system (104c) and the endpoint (102b) must also communicate via the data communications network (106).

In the example of FIG. 1A, each management system (104a, 104b, 104c) is configured to communicate with other management systems (104a, 104b, 104c). For example, management system (104a) is configured to communicate directly with management system (104b) and configured to communicate with management system (104c) via the data communications network (106). In the example of FIG. 1A, management systems (104a, 104b, 104c) communicate with each other to, for example, determine whether an endpoint (102a, 102b, 102c) in the computing system (108) is being monitored by two or more management systems (104a, 104b, 104c), to select, from among the two or more management systems (104a, 104b, 104c), a primary management system that is responsible for monitoring a particular endpoint (102a, 102b, 102c), and to assign the primary management system to monitor the endpoint (102a, 102b, 102c).

The arrangement of servers and other devices making up the exemplary system illustrated in FIG. 1A are for explanation, not for limitation. Data processing systems useful according to various embodiments of the present invention may include additional endpoints, management systems, servers, routers, other devices, and peer-to-peer architectures, not shown in FIG. 1A, as will occur to those of skill in the art. Networks (106) in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1A.

FIG. 1B sets forth a block diagram of apparatus for reducing redundant error messages in a computing system (108) according to embodiments of the present invention. In the example of FIG. 1B, the management systems (104a, 104b, 104c) have negotiated such that only a single management system (104a, 104b, 104c) is monitoring each endpoint (102a, 102b, 102c). In the example of FIG. 1B, endpoint (102a) is monitored by management system (104a), endpoint (102b) is monitored by management system (104b), and endpoint (102c) is monitored by management system (104c).

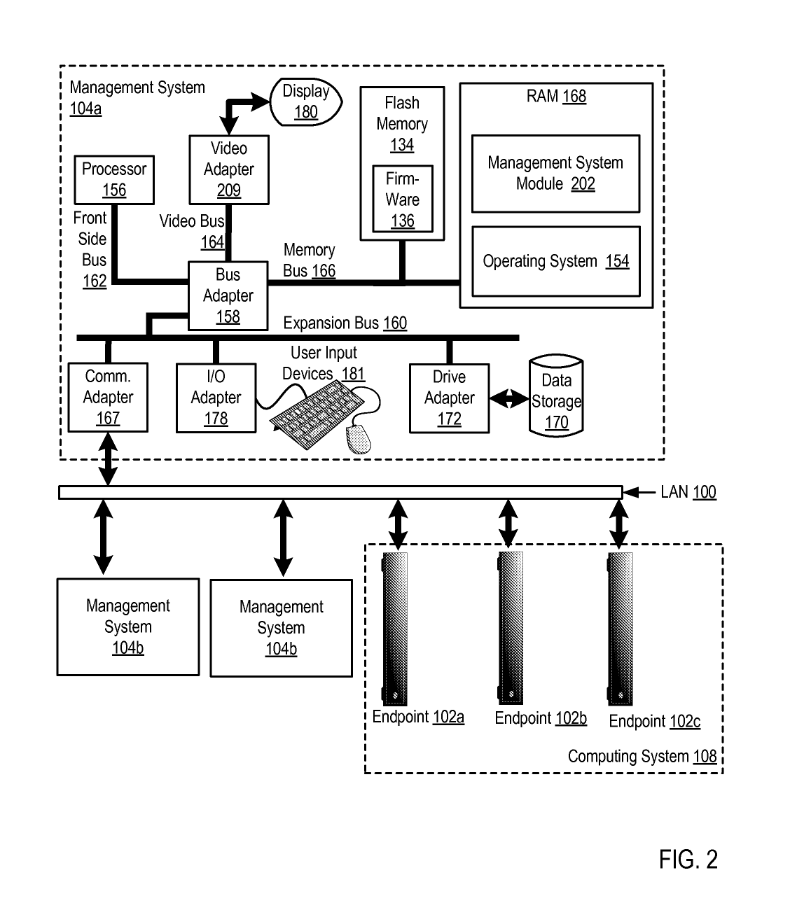

Reducing redundant error messages in a computing system in accordance with the present invention is generally implemented with computers, that is, with automated computing machinery. In the systems of FIG. 1A and FIG. 1B, for example, the endpoints, management systems, and network are implemented to some extent at least as computers. For further explanation, therefore, FIG. 2 sets forth a block diagram of automated computing machinery comprising an exemplary management system (104a) useful in reducing redundant error messages in a computing system according to embodiments of the present invention. The management system (104a) of FIG. 2 includes at least one computer processor (156) or ‘CPU’ as well as random access memory (168) (‘RAM’) which is connected through a high speed memory bus (166) and bus adapter (158) to processor (156) and to other components of the management system (104a).

Stored in RAM (168) is a management system module (202), a module of computer program instructions for reducing redundant error messages in a computing system (108) according to embodiments of the present invention. The management system module (202) includes computer program instructions for determining whether an endpoint (102a, 102b, 102c) in the computing system (108) is being monitored by two or more management systems (104a, 104b, 104c), selecting in dependence upon a negotiation algorithm, from among the two or more management systems (104a, 104b, 104c), a primary management system that is responsible for monitoring the endpoint (102a, 102b, 102c), and assigning the primary management system to monitor the endpoint (102a, 102b, 102c).

Also stored in RAM (168) is an operating system (154). An operating system is a computer software component that is responsible for execution of applications programs and for administration of access to computer resources, memory, processor time, and I/O functions, on behalf of application programs. Operating systems useful reducing redundant error messages in a computing system according to embodiments of the present invention include UNIX™, Linux™, Microsoft XP™, AIX™, IBM's i5/OS™, and others as will occur to those of skill in the art. The operating system (154) and management system module (202) in the example of FIG. 2 are shown in RAM (168), but many components of such software typically are stored in non-volatile memory also, such as, for example, on a disk drive (170).

The management system (104a) of FIG. 2 includes disk drive adapter (172) coupled through expansion bus (160) and bus adapter (158) to processor (156) and other components of the management system (104a). Disk drive adapter (172) connects non-volatile data storage to the management system (104a) in the form of disk drive (170). Disk drive adapters useful in computers for reducing redundant error messages in a computing system according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example management system (104a) of FIG. 2 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example management system (104a) of FIG. 2 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary management system (104a) of FIG. 2 includes a communications adapter (167) for data communications with other management systems (104b, 104c), endpoints (102a, 102, 102c), and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art.

Communications adapters implement the hardware level of data communications through which one computer sends data communications to another computer, directly or through a data communications network. Examples of communications adapters useful for reducing redundant error messages in a computing system according to embodiments of the present invention include modems for wired dial-up communications, Ethernet (IEEE 802.3) adapters for wired data communications network communications, and 802.11 adapters for wireless data communications network communications.

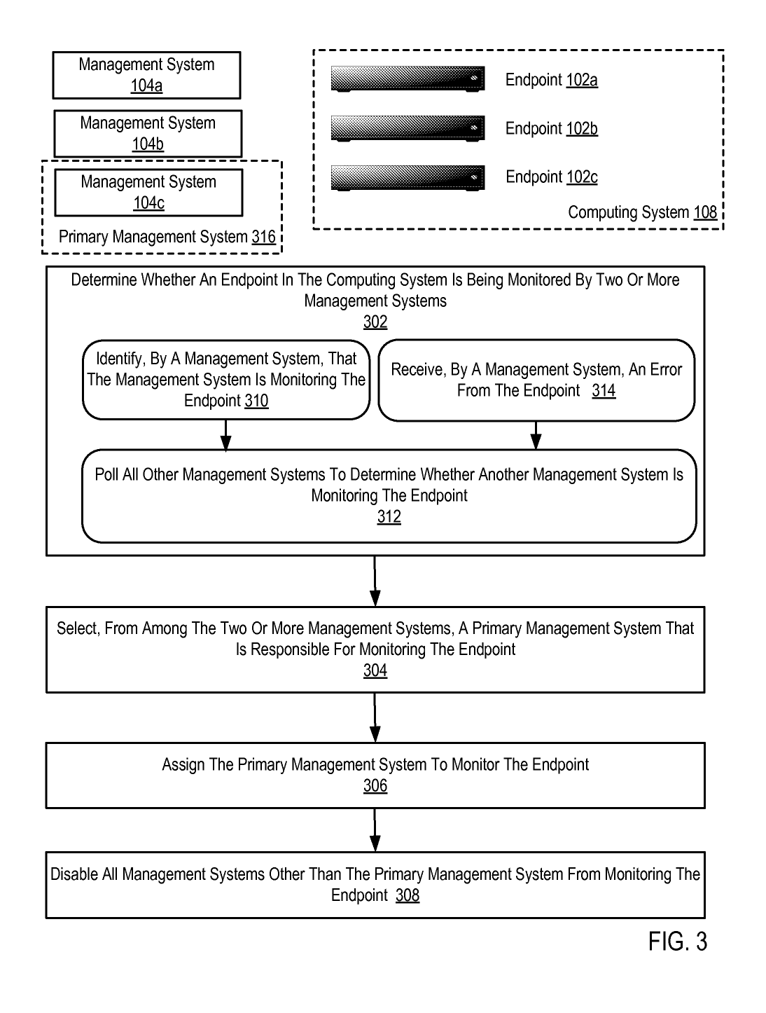

For further explanation, FIG. 3 sets forth a flow chart illustrating an example method for reducing redundant error messages in a computing system (108) according to embodiments of the present invention that includes determining (302) whether an endpoint (102a, 102b, 102c) in the computing system (108) is being monitored by two or more management systems (104a, 104b, 104c). In the example of FIG. 3, determining (302) whether an endpoint (102a, 102b, 102c) in the computing system (108) is being monitored by two or more management systems (104a, 104b, 104c) may include identifying (310) by a management system (104a, 104b, 104c), that the management system (104a, 104b, 104c) is monitoring the endpoint (102a, 102b, 102c).

The management system (104a, 104b, 104c) may identify (310) that the management system (104a, 104b, 104c) is monitoring the endpoint (102a, 102b, 102c), for example, through the use of a directory of registered endpoints (102a, 102b, 102c) that is maintained within the management system (104a, 104b, 104c). In such an example, the management system (104a, 104b, 104c) may maintain a directory of endpoints (102a, 102b, 102c) that have registered to be monitored by the management system (104a, 104b, 104c). By maintaining such a directory, the management system (104a, 104b, 104c) can search the directory to determine whether the endpoint (102a, 102b, 102c) has registered for monitoring with the management system (104a, 104b, 104c).

In the example of FIG. 3, determining (302) whether an endpoint (102a, 102b, 102c) in the computing system (108) is being monitored by two or more management systems (104a, 104b, 104c) may alternatively include receiving, by a management system (104a, 104b, 104c), an error from the endpoint (102a, 102b, 102c). In such an example, if the management system (104a, 104b, 104c) receives an error message from a particular endpoint (102a), the management system (104a, 104b, 104c) may determine that the management system management system (104a, 104b, 104c) is monitoring the particular endpoint (102a).

In the example of FIG. 3, determining (302) whether an endpoint (102a, 102b, 102c) in the computing system (108) is being monitored by two or more management systems (104a, 104b, 104c) may also include polling (312) all other management systems (104a, 104b, 104c) to determine whether another management system (104a, 104b, 104c) is monitoring the endpoint (102a, 102b, 102c). Polling (312) all other management systems (104a, 104b, 104c) to determine whether another management system (104a, 104b, 104c) is monitoring the endpoint (102a, 102b, 102c) may be carried out, for example, by having a particular management system (104a) send a message, that includes an identifier for a particular endpoint (102a), to all other management systems (104b, 104c) querying the other management systems (104b, 104c) as to whether each management system (104b, 104c) monitors the identified endpoint (102a). In such an example, each management system (104b, 104c) may search its own directory of registered endpoints (102a, 102b, 102c) to determine whether the endpoint (102a) identified in the message is registered with the other management systems (104b, 104c). The other management systems (104b, 104c) may then respond to the particular management system (104a) that sent the message, indicating whether each management system (104b, 104c) monitors the identified endpoint (102a).

The example of FIG. 3 also includes selecting (304) in dependence upon a negotiation algorithm, from among the two or more management systems (104a, 104b, 104c), a primary management system (316) that is responsible for monitoring the endpoint (102a, 102b, 102c). In the example of FIG. 3, the negotiation algorithm includes criteria for selecting a primary management system (316). Criteria can include, for example, physical proximity of a particular management system (104a, 104b, 104c) to the endpoint (102a, 102b, 102c) to be monitored, the amount of available resources that each management system (104a, 104b, 104c) has available for monitoring the endpoint (102a, 102b, 102c), and so on. The negotiation algorithm can take multiple criterion into account according to some formula and calculate a compatibility score, such that the management system (104a, 104b, 104c) with the highest compatibility score is tasked with the responsibility of monitoring the endpoint (102a, 102b, 102c).

In the example of FIG. 3, the negotiation algorithm may be implemented, for example, by a single management system (104a, 104b, 104c) that receives criteria data from all other management systems (104a, 104b, 104c). In such an example, the management system (104a, 104b, 104c) that received criteria data from all other management systems (104a, 104b, 104c) may subsequently apply the negotiation algorithm to the data received from all other management systems (104a, 104b, 104c), as well as to its own criteria data, such that the management system (104a, 104b, 104c) that received criteria data from all other management systems (104a, 104b, 104c) discovers which management system (104a, 104b, 104c) should be designated as the primary management system (316) for an endpoint (102a, 102b, 102c), and notifies all other management systems (104a, 104b, 104c) of the results.

In the example of FIG. 3, selecting (304) a primary management system (316) that is responsible for monitoring the endpoint (102a, 102b, 102c) may be carried out, for example, through a peer-to-peer negotiation process between two or more of the management systems (104a, 104b, 104c). The management systems (104a, 104b, 104c) may negotiate, for example, by determining which management system (104a, 104b, 104c) is physically more proximate to the endpoint (102a, 102b, 102c), by determining which management system (104a, 104b, 104c) has the most resources available to monitor the endpoint (102a, 102b, 102c), by determining which management system (104a, 104b, 104c) is better equipped to monitor a resource of the particular type (e.g., software endpoint, power supply endpoint, memory endpoint) of the endpoint (102a, 102b, 102c), and so on. In the example of FIG. 3, selecting (304) a primary management system (316) that is responsible for monitoring the endpoint (102a, 102b, 102c) may be carried out, for example, by a master management system (104a, 104b, 104c) or other management system (104a, 104b, 104c) controller that determines which master management system (104a, 104b, 104c) is responsible for monitoring the endpoint (102a, 102b, 102c) by using a round-robin assignment algorithm, load balancing algorithm, and so on.

The method of FIG. 3 also includes assigning (306) the primary management system (316) to monitor the endpoint (102a, 102b, 102c). In the example of FIG. 3, assigning (306) the primary management system (316) to monitor the endpoint (102a, 102b, 102c) may be carried out, for example, by writing an identifier for the endpoint (102a, 102b, 102c) into a directory of monitored endpoints within the primary management system (316). Alternatively, assigning (306) the primary management system (316) to monitor the endpoint (102a, 102b, 102c) may be carried out by instructing the endpoint (102a, 102b, 102c) to report errors and other exceptions to the primary management system (316) only. In the example of FIG. 3, management system (104c) has been assigned (306) as the primary management system (316).

The method of FIG. 3 also includes disabling (308) all management systems other than the primary management system (316) from monitoring the endpoint (102a, 102b, 102c). In the example of FIG. 3, disabling (308) all management systems (104a, 104b, 104c) other than the primary management system (316) from monitoring the endpoint (102a, 102b, 102c) may be carried out, for example, by removing an identifier for the endpoint (102a, 102b, 102c) from a directory of monitored endpoints within all management systems (104a, 104b, 104c) other than the primary management system (316), by writing an identifier for the endpoint (102a, 102b, 102c) into a directory of blocked endpoints within all management systems (104a, 104b, 104c) other than the primary management system (316), an in other ways as will occur to those of skill in the art.

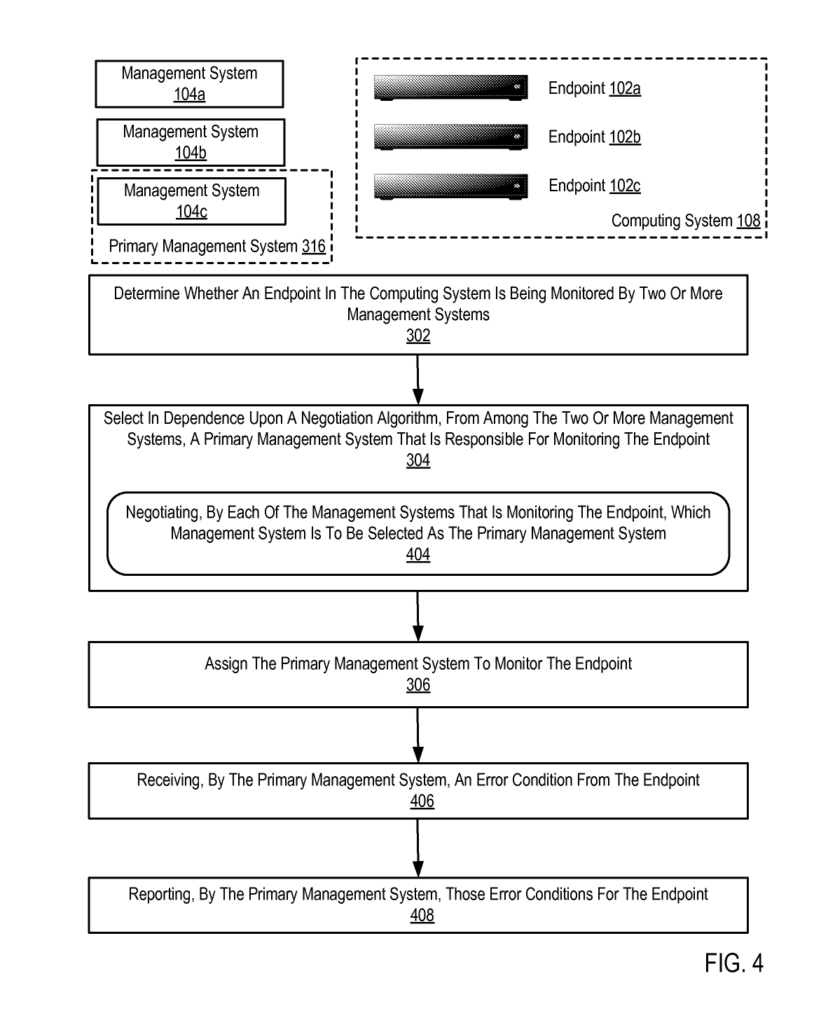

For further explanation, FIG. 4 sets forth a flow chart illustrating a further exemplary method for reducing redundant error messages in a computing system (108) according to embodiments of the present invention. The example of FIG. 4 is similar to the example of FIG. 3 as it also includes determining (302) whether an endpoint (102a, 102b, 102c) in the computing system (108) is being monitored by two or more management systems (104a, 104b, 104c), selecting (304) in dependence upon a negotiation algorithm, from among the two or more management systems (104a, 104b, 104c), a primary management system (316) that is responsible for monitoring the endpoint (102a, 102b, 102c), and assigning (306) the primary management system (316) to monitor the endpoint (102a, 102b, 102c).

In the example of FIG. 4, monitoring the endpoint (102a, 102b, 102c) includes monitoring errors reported by the endpoint (102a, 102b, 102c). Errors can indicate a hardware or software failure. Errors can indicate, for example, that a particular hardware component has failed, that a particular hardware component is not operating as expected, that a particular hardware component has encountered an unexpected condition, that a software component has encountered an unexpected condition, and so on.

In the example of FIG. 4, monitoring the endpoint (102a, 102b, 102c) may also include monitoring performance conditions at the endpoint (102a, 102b, 102c). Performance conditions represent a particular performance level of a hardware component or software component. Performance conditions may include, for example, processor utilization metrics, memory utilization metrics, power utilization metrics, a number of interrupts experienced by a particular software application, and so on.

In the example of FIG. 4, selecting (304) a primary management system (316) that is responsible for monitoring the endpoint (102a, 102b, 102c) may include negotiating (404), by each of the management systems (104a, 104b, 104c) that is monitoring the endpoint (102a, 102b, 102c), which management system (104a, 104b, 104c) is to be selected as the primary management system (316). In the example of FIG. 4, the negotiation algorithm may be implemented, for example, on every management system (104a, 104b, 104c) such that each management system (104a, 104b, 104c) receives criteria related data from all other management systems (104a, 104b, 104c). Each management system (104a, 104b, 104c) may subsequently apply the negotiation algorithm to the data received from all other management systems (104a, 104b, 104c), as well as to its own criteria data, such that each management system (104a, 104b, 104c) discovers which management system (104a, 104b, 104c) should be designated as the primary management system (316) for an endpoint (102a, 102b, 102c).

The example of FIG. 4 also includes receiving (406), by the primary management system (316), an error condition from the endpoint (102a, 102b, 102c). The error condition may indicate that a particular hardware component or software component has failed, that a particular hardware component or software component is operating in an unexpected manner, that a particular hardware component or software component has experience an unexpected operating condition, and so on. Receiving (406) such an error condition may be carried out, for example, by receiving a message or other form of communication from the endpoint (102a, 102b, 102c).

The example of FIG. 4 also includes reporting (408), by the primary management system (316), those error conditions for the endpoint (102a, 102b, 102c). In the example of FIG. 4, the error conditions may be reported (408) by, for example, writing the errors to an error log, sending a message to a system administrator containing an error message, sending messages to an error resolution tool, and so on.

Exemplary embodiments of the present invention are described largely in the context of a fully functional computer system for reducing redundant error messages in a computing system. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of reducing redundant error messages in a computing system, the method comprising:
determining whether an endpoint in the computing system is being monitored by two or more management systems;
selecting in dependence upon a negotiation algorithm, from among the two or more management systems, a primary management system that is responsible for monitoring the endpoint; and
assigning the primary management system to monitor the endpoint.

2. The method of claim 1 further comprising disabling all management systems other than the primary management system from monitoring the endpoint.

3. The method of claim 1 wherein determining whether an endpoint is being monitored by two or more management systems includes:
identifying, by a management system, that the management system is monitoring the endpoint; and
polling all other management systems to determine whether another management system is monitoring the endpoint.

4. The method of claim 1 wherein determining whether an endpoint is being monitored by two or more management systems includes:
receiving, by a management system, an error from the endpoint; and
polling all other management systems to determine whether another management system is monitoring the endpoint.

5. The method of claim 1 wherein selecting a primary management system that is responsible for monitoring the endpoint includes negotiating, by each of the management systems that is monitoring the endpoint, which management system is to be selected as the primary management system.

6. The method of claim 1 further comprising:
receiving, by the primary management system, an error condition from the endpoint; and
reporting, by the primary management system, those error conditions for the endpoint.

7. The method of claim 1 wherein monitoring the endpoint includes monitoring errors reported by the endpoint.

8. The method of claim 1 wherein monitoring the endpoint includes monitoring performance conditions at the endpoint.

9. Apparatus for reducing redundant error messages in a computing system, the apparatus comprising a computer processor, a computer memory operatively coupled to the computer processor, the computer memory having disposed within it computer program instructions that, when executed by the computer processor, cause the apparatus to carry out the steps of:
determining whether an endpoint in the computing system is being monitored by two or more management systems;
selecting in dependence upon a negotiation algorithm, from among the two or more management systems, a primary management system that is responsible for monitoring the endpoint; and
assigning the primary management system to monitor the endpoint.

10. The apparatus of claim 9 further comprising computer program instructions that, when executed by the computer processor, cause the apparatus to carry out the step of disabling all management systems other than the primary management system from monitoring the endpoint.

11. The apparatus of claim 9 wherein determining whether an endpoint is being monitored by two or more management systems includes:
identifying, by a management system, that the management system is monitoring the endpoint; and
polling all other management systems to determine whether another management system is monitoring the endpoint.

12. The apparatus of claim 9 wherein determining whether an endpoint is being monitored by two or more management systems includes:
receiving, by a management system, an error from the endpoint; and
polling all other management systems to determine whether another management system is monitoring the endpoint.

13. The apparatus of claim 9 wherein selecting a primary management system that is responsible for monitoring the endpoint includes negotiating, by each of the management systems that is monitoring the endpoint, which management system is to be selected as the primary management system.

14. The apparatus of claim 9 further comprising computer program instructions that, when executed by the computer processor, cause the apparatus to carry out the steps of:
receiving, by the primary management system, an error condition from the endpoint; and
reporting, by the primary management system, those error conditions for the endpoint.

15. A computer program product for reducing redundant error messages in a computing system, the computer program product disposed upon a computer readable storage medium, the computer program product comprising computer program instructions that, when executed, cause a computer to carry out the steps of:
determining whether an endpoint in the computing system is being monitored by two or more management systems;
selecting in dependence upon a negotiation algorithm, from among the two or more management systems, a primary management system that is responsible for monitoring the endpoint; and
assigning the primary management system to monitor the endpoint.

16. The computer program product of claim 15 further comprising computer program instructions that, when executed, cause a computer to carry out the step of disabling all management systems other than the primary management system from monitoring the endpoint.

17. The computer program product of claim 15 wherein determining whether an endpoint is being monitored by two or more management systems includes:
identifying, by a management system, that the management system is monitoring the endpoint; and
polling all other management systems to determine whether another management system is monitoring the endpoint.

18. The computer program product of claim 15 wherein determining whether an endpoint is being monitored by two or more management systems includes:
receiving, by a management system, an error from the endpoint; and
polling all other management systems to determine whether another management system is monitoring the endpoint.

19. The computer program product of claim 15 wherein selecting a primary management system that is responsible for monitoring the endpoint includes negotiating, by each of the management systems that is monitoring the endpoint, which management system is to be selected as the primary management system.

20. The computer program product of claim 15 further comprising computer program instructions that, when executed, cause a computer to carry out the steps of:
receiving, by the primary management system, an error condition from the endpoint; and
reporting, by the primary management system, those error conditions for the endpoint.
